(19) United States
(12) Patent Application Publication
(10) Pub. No.: US 2008/0059076 A1
(43) Pub. Date: Mar. 6, 2008

(54) Method for classifying leaves utilizing venation features

(75) Inventors: Hong Keun Choi, Suwon (KR); Een Jun Hwang, Seoul (KR); Hyun Chur Shin, Asan-si (KR); Yun Young Nam, Suwon (KR); Jin Kyu Park, Seoul (KR)

Correspondence Address: GWIPS;PETER T. KWON, P.O. BOX 231630, CENTERVILLE, VA, 20120, US

(73) Assignee: Ajou University Industry- Academic Cooperation Foundation

(21) Appl. No.: 11/594,450

(22) Filed: Nov. 8, 2006

(30) Foreign Application Priority Data
Sep. 6, 2006 (KR) 10-2006-0085444

(51) Int. Cl. G06F 19/00; G06T 7/40

(52) U.S. Cl. 702/19; 382/120

(57) ABSTRACT

A method for classifying a plant leaf by utilizing the feature points of venation has been developed. A sample image of the venation can be extracted by utilizing a Curvature Scale Space (CSS) Corner Detection Algorithm. The sample image is treated to thicken the venation and increase the contrast through the retrieval unit prior to applying the Canny Edge Detection technology. The feature point, Branching Point and End Point is detected at each point where the calculated curvature angle is a local maximum. The distribution of the feature points of the extracted venation is calculated by applying a Parzen Window non-parametric estimation method.

### BACKGROUND OF THE INVENTION

1. Field of the Invention

The present invention relates to a method for classifying plant leaves by utilizing the feature points, Branching Points (BP) and Ending Points (EP), associated with its vein patterns. More particularly, the feature points are extracted from a sample image of venation by applying a Curvature Scale Space (CSS) Corner Detection Algorithm. Then, the density of the extracted venation is calculated using a Parzen Window non-parametric estimation method.

2. Related Prior Art

The present invention introduces a method for classifying leaves by utilizing the venation features.

Recently, research into various plants has actively progressed due to the escalation of the public's interest in nature and the environment.

By virtue of advanced computer and network technologies, the internet and digital cameras are readily available to the general public and popular with individuals. Therefore, many people can easily examine and observe various plants and save the gathered information in databases to be used as research data.

However, many people normally input a plant terminology as a keyword when they want to retrieve certain information about a plant through a specific site. But, if the people do not know the plant terminology, it is difficult to retrieve certain information about the plant.

Accordingly, the present inventors have suggested an easy way to search certain plant information. They also have filed a Korean Patent Application (KIPO No.: 2005-0063271), entitled “Method of Searching the Leaf Images based on the Shapes and Venation Features.”

The conventional method of searching plant leaves includes: (i) sketching the shape of the various plant leaves, (ii) extracting the feature points and feature shapes of plant leaves by using the Minimum Perimeter Polygon (MPP) techniques for establishing the database, (iii) retrieving a specific feature shape of a leaf, such as a sketch, picture, and prototype of the leaf, according to the user's request, and (iv) searching and retrieving the leaf data that satisfies the requested feature points of the leaf.

Because the number of the feature points for the various feature shapes extracted by the conventional method is different for every leaf image, it has a problem for the searcher to correctly retrieve the wanted information of a certain plant leaf.

In addition, there is another method suggested for searching the plant leaves using physical characteristics, such as the texture and color, to categorize the plant leaves. Because most plant leaves have similar texture and color, it is also difficult to retrieve the correct plant information with this method.

### SUMMARY OF THE INVENTION

In order to accomplish the aforementioned purpose, a method for classifying a plant leaf of the present invention is developed by utilizing the feature points of the venation, the method comprising the steps of: (a) a sample image of venation is extracted from a leaf for inputting to an input unit (120) (S401).

(b) A series of feature points, known as Branching Points (BP) and Ending Points (EP), are detected from the extracted sample image of venation by applying a Curvature Scale Space (CSS) Corner Detection Algorithm (S405).

(c) The feature points, BP and EP of the extracted venation are classified through an analysis unit (140) (S407).

(d) The series of detected feature points (BP and EP) are checked to verify whether they are distributed along a line or around a point by calculating the probability density function (PDF) of the feature points (BP and EP) of the extracted venation using the Parzen Window non-parametric estimation method (S409).

(e) According to the previous step of calculating the distribution of the detected feature points, the venation pattern is classified as either parallel or non-parallel; if the feature points (BP and EP) are clustered around a point at the top and/or bottom of the leaf, it is parallel, and if the feature points (BP and EP) are distributed along a line, it is non-parallel, (S410).

(f) Based on the previous decision step, if it is determined to be a parallel venation, the pattern is further classified as a first parallel venation, if the BP at the top end are densely clustered around a point, while the BP at the bottom end are also densely clustered around a point (S428), or a second parallel venation, if the BP at the top end are densely clustered around a point while the BP at the bottom are distributed along a line (S425).

(g) If it is not the parallel venation according to the previous decision step, the BP distribution direction is analyzed again as to whether the distribution of the BP form a longitudinal line from the top to the bottom (S435).

Finally, (h) a pinnate venation is classified, if the BP are distributed along a longitudinal line from the top to the bottom (S436), and a palmate venation is classified, if the BP are densely clustered around a point at the bottom end of the leaf (S439).

### BRIEF DESCRIPTION OF THE DRAWINGS

FIG. 1 shows a Data Processing Computer System for classifying the various plant leaves by utilizing the feature points of the present invention.

FIG. 2 shows plant leaves having various feature points of the venation as described in the present invention.

FIG. 3 is a computer processing flow chart for classifying various plant leaves by utilizing the feature points of the present invention.

FIG. 4 shows the process of extracting the feature points from a venation by using a Curvature Scale Space (CSS) Corner Detection Algorithm of the present invention.

FIG. 5 is an example of a detecting method to determine a Branching Point (BP) of the present invention.

FIG. 6 is an example method to classify the feature points of the present invention.

FIG. 7 is a density distribution of the feature points between the perpendicular and normal lines of the present invention.

FIG. 8 is an example of a first parallel venation illustrating a calculation of the density of feature points of the present invention, including a graph of the density underneath.

### DETAILED DESCRIPTION OF THE PREFERRED EMBODIMENTS

Hereinafter, a method for classifying plant leaves by utilizing the feature points, in particular Branching Points (BP) and Ending Points (EP) of the present invention is described in detail with reference to the accompanying drawings.

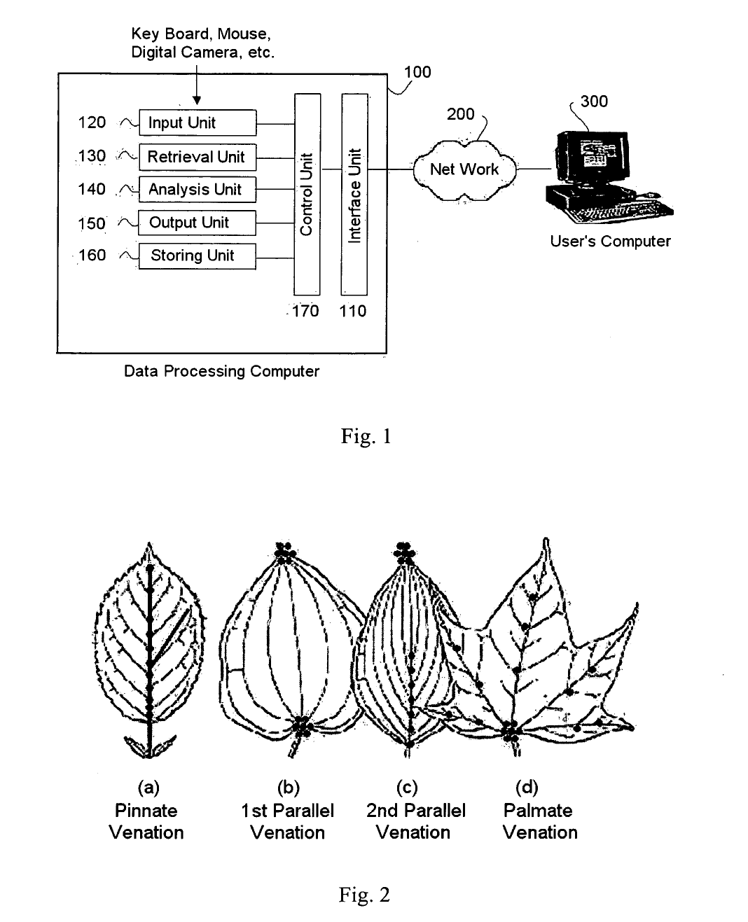

FIG. 1 represents the Data Processing Computer System for classifying various plant leaves by utilizing the feature points. FIG. 2 represents the four types of leaves having various feature points of the venation.

As represented in FIG. 1, the system for classifying plant leaves by using the venation features is comprised of a Data Processing Computer (100), a network (200) and a user computer (300).

The Data Processing Computer (100) further comprises an interface unit (110), input unit (120), retrieval unit (130), analysis unit (140), output unit (150), storing unit (160) and controlling unit (170).

The interface unit (110) is capable of exchanging the specific plant information with the user computer (300) through the network (200) according to the users' demand.

Even though the input unit (120) is not shown in a detailed drawing, it is a device for entering the data regarding the leaf venation of various plants, including a keyboard, mouse, digitizer, scanner, digital camera, cell phone and Personal Digital Assistant (PDA). The user computer (300) is equipped with the same peripheral accessories as the input unit (120).

The retrieval unit (130) retrieves the sample image of the leaf venation that is input through the input unit (120). The feature shape of the leaf venation is extracted by using the Canny Edge Detection technique. In addition, the Branching Points (BP) and Ending Points (EP) of the leaf venation are detected by applying a Curvature Scale Space Corner Detection (known as the CSS algorithm).

Herein, the curvature rate of the points on the curve is calculated by the CSS algorithm to detect the corner point that has the maximum value of the curvature rate. Generally, the majority of the leaves have the maximum value of the curvature rate at the Branching Point (BP) or Ending Point (EP).

On the other hand, the leaf venation is determined not only by the internal feature shape of the leaf, but also the veins of the plant. Because the feature shapes of the leaf venation are different from one another depending on the type of plant, the feature points of the venation are extracted and categorized to utilize and retrieve the various plant data in this specification.

The density of the feature points extracted from the venation is retrieved through the retrieval unit (130). Then, the analysis unit (140) performs a calculation for the density of feature points from a subset of the feature point data using the Parzen Window technique that adopts a non-parametric estimation. After verifying the distribution of the Branching Points and Ending Points, the leaf venation is categorized as one of four types: (a) Pinnate Venation, (b) first Parallel Venation, (c) second Parallel Venation, or (d) Palmate Venation, according to the distribution of the feature points.

As shown in FIG. 2, the Pinnate Venation (a) has a large primary vein at the center, and a multiplicity of lateral veins branched out from the primary vein to form a feather shape.

Namely, the longitudinal line (or perpendicular line) from the top end to the bottom end of the leaf, on the sample image is considered the primary vein. The Branching Points (BP) on the sample image are considered the junction points where the multiplicity of lateral veins are branched out from the primary vein. When a series of the BP are discovered along a perpendicular line, the leaf is classified as the Pinnate Venation (a).

The Parallel Venations (b and c) have a multiplicity of primary veins split from the petiole and running parallel from the bottom end to the top end of the leaf. If there is a high density of the Ending Point distribution at the top end and the bottom end of the leaf, it is classified as a First Parallel Venation (c). If it has a primary vein at the lower bottom of the leaf and the lateral veins branched out from the primary vein and running parallel from the bottom end to the top end of the leaf, it is classified as a Second Parallel Venation (c).

The Palmate Venation (d) has more than three primary veins split out from the base of the leaf blade to form a palm-like shape.

On the other hand, the output unit (150) displays the input image Data which are related to the leaf venation of the various plants input through the input unit (120).

The storing unit (160) maintains the operational information for operating the Data Processing Computer (100) and various software and algorithms for extracting and analyzing the feature points of the leaf venation.

The controlling unit (170) regulates each unit (110˜170) in the system for providing information about the various leaf venations and performing the various mathematical operations to calculate the feature points. The controlling unit (170) also supplies the corresponding leaf venation to the user computer (300) whenever the user retrieves a record.

On the other hand, the network (200) may be the wired internet, such as a TCP/IP protocol, or the wireless WAP protocol that is wirelessly accessed through a computer.

In addition, the user can receive the information about the needed plant leaf venation at the user's computer (300) from the data processing computer (100) via the network (200).

At this moment, the data processing computer (100) and the user computer (300) must have a communication capability equipped with internet browsers that can display web content and a PC, such as a desktop computer or notebook computer. The personal computer is recommended to have an operating system of at least Windows 98, at least a Pentium grade CPU processor, and more than 64 Mb of RAM.

Even though the PC is described as the user computer (300) in this disclosure, it can be a PDA, or a cell phone with wireless internet capabilities and IMT-2000 as long as it is capable to receive and search information of the various plant leaf venations from the data processing computer (100).

Referring to FIGS. 1 to 8, the method for classifying leaves by using feature points of the venation of the present invention is described in detail.

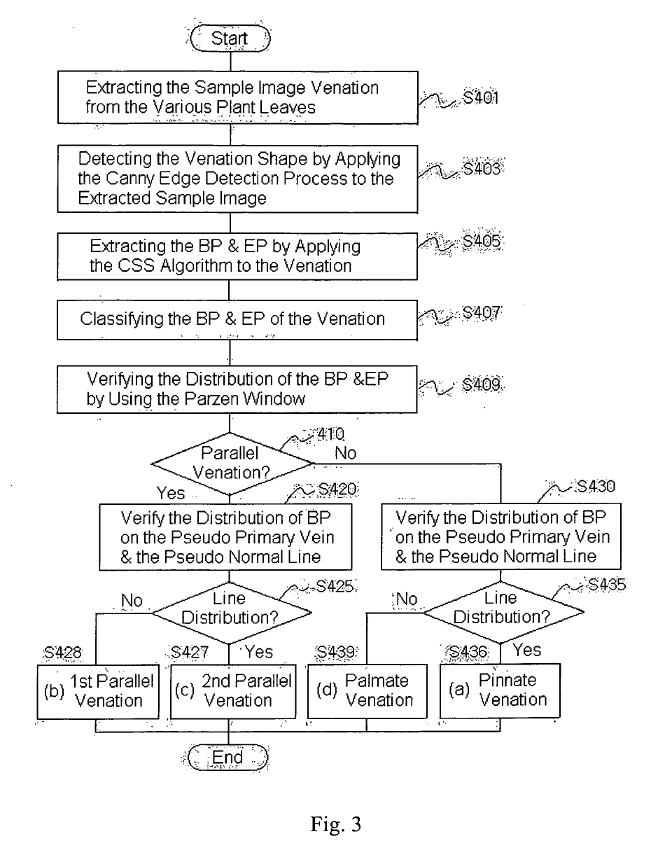

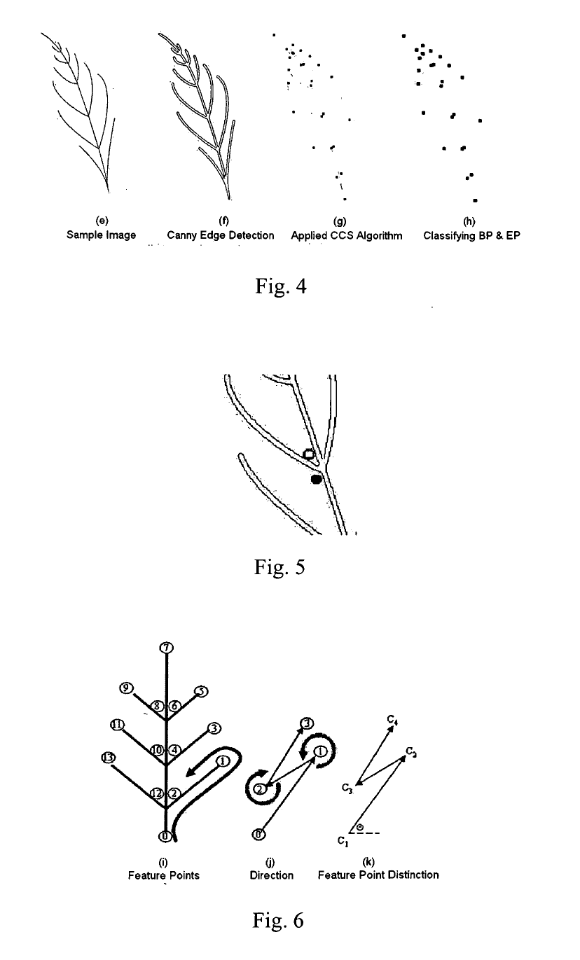

FIG. 3 is a flow chart illustrating the method for classifying leaves by using feature points of the venation. FIG. 4 shows the process of extracting the feature points (BP and EP) from a venation by applying a Curvature Scale Space (CSS) Corner Detection Algorithm.

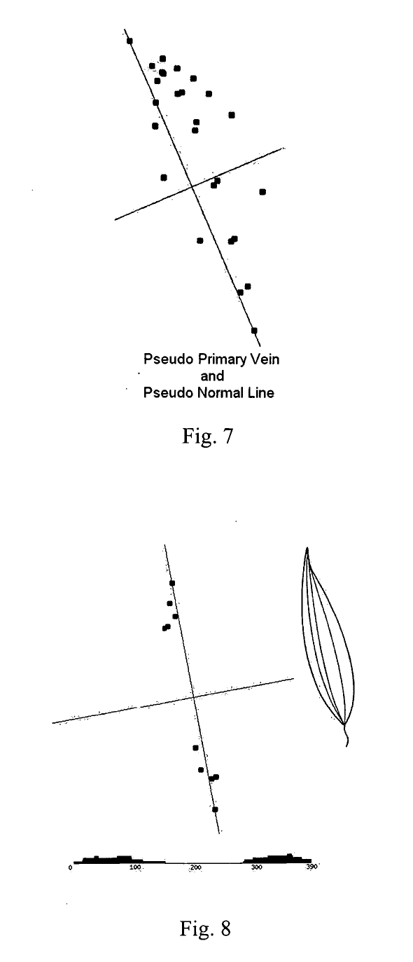

FIG. 5 shows an example of a detecting method to determine a Branching Point (BP). FIG. 6 is an example of a method to classify the feature points. FIG. 7 is a density distribution of the feature points between the longitudinal (or perpendicular) and lateral lines.

FIG. 8 is an example of a first parallel venation illustrating the calculation of the density of feature points, and includes a graph underneath thereof.

As shown in FIG. 4(e), the data processing computer (100) receives from the input unit (120) a sample image of venation extracted from a leaf that the user wants to compare to existing records in the database (S401).

As shown in FIG. 4(f), the data processing computer (100) detects the feature curve shape of the leaf venation by performing the Canny Edge Detection technique on the sample image extracted from the previous step (S403).

At this moment, the sample image must be favorably detected as a continuous single curve. As shown in FIG. 4(e), the image of venation is often detected to be made up of several curves or a curve that is broken in the middle. These incidents are caused from inadequate thickness of the leaf venation. It is problematic because it introduces broken veins during the process of the Canny Edge Detection technique.

Accordingly, it would be favorable to increase the venation thickness and the contrast of the image of venation before applying the Canny Edge Detection technique.

As shown in FIG. 4(g), the data processing computer (100) detects a series of Branching Points (BP) and Ending Points (EP) from the extracted sample image of venation by applying the Curvature Scale Space (CSS) Corner Detection technique (CSS algorithm) (S405).

If the CSS algorithm is applied to the leaf venation, it will have the maximum value of the curvature rate at the feature points (BP and EP). Therefore, it is possible to detect the location of the feature points.

However, there is a problem raised at the point of BP where the venation is branched-out, because the maximum curvature value is possibly detected at two spots.

As shown in FIG. 5, the two spots with the maximum value of angles are represented as a black spot () and a white spot (◯). Since each Branching Point on the venation must be represented by one spot, the angles of the spots are calculated to select the spot that has an angle of less than 90° as one Branching Point (BP). Therefore, the white spot (◯) located above the BP will be selected as a feature point, and the black spot () located below the BP will be ignored.

Next, the data processing computer (100) classifies the feature points as either Branching Points (BP) or Ending Points (EP), as represented in FIG. 4(h) (S407).

Actually, the Ending Point \textcircled{1} as shown in FIG. 6(j) changes its direction toward the left at an Ending Point, and changes toward the right at a Branching Point \textcircled{2}.

When three neighboring points (C1, C2, C3) are continuously located along the progressing direction as shown in FIG. 6(k), it is possible to determine whether the intermediate point C2 represents a Branching Point or an Ending Point based on the whether the point C3 is located above or below the progressing direction C̅₁̅C̅₂̅.

If the point C3 is located above this progressing direction, the Ending Point (EP) will end up oriented toward the left based on the progressing direction. On the contrary, the point C3 will be a Branching Point (BP). If the angle (θ) is defined between the progressing direction C̅₁̅C̅₂̅ and the x-axis, the point C3′ will be located on the y-axis where the point C3 is rotated by −θ degrees with respect to the point C2.

If the progressing direction is counter-clockwise, it will be the Ending Point (EP) as seen in FIG. 6(i) when the point C3′ has a positive value on the y-coordinate. On the contrary, it will be the Branching Point (BP) when the point C3′ has a negative value on the y-coordinate.

In contrast, if the progressing direction is clockwise, it will be the Branching Point (BP) as seen in FIG. 6(i) when the point C3′ has a positive value on the y-coordinate. On the contrary, it will be the Ending Point (EP) when the point C3′ has a negative value on the y-coordinate.

Therefore, the algorithm for classifying each feature point, Branching Point (BP) and Ending Point (EP) is presented in Table 1.

TABLE 1

```
function CornerDistinct(C₁, C₂, C₃, direction)
{
  θ ← an angle between vector [symbol] and x-axis
  C′₃ ← rotation of C₃ around C₂ at − θ
  if C′₃.y > 0
    state ← Ending Point
  else
    state ← Branching Point
  end if
  if direction is counter-clockwise
    return state
  else
    return !state
  end if
}
```

For determining the progressing direction, set a starting point of the venation on the bottom end of the leaf as a base point to verify whether the progressing direction is clockwise or counter-clockwise by comparing the former point and latter point on the x-coordinate.

The venation extracted through the previous step (S407-h) is presented in FIG. 4 to be classified based on the detected feature points of the BP and EP (S407). The black spots disposed along the exterior leaf represent the Ending Points (EP) whereas the gray spots disposed along the central primary vein represent the Branching Points (BP).

Then, the data processing computer (100) verifies whether the detected feature points (BP and EP) are distributed along a line or around a point by calculating the density of the feature points (BP and EP) of the extracted venation using a non-parametric estimation method of the Parzen Window type (S409).

Practically, the distribution of the feature points should be analyzed to determine whether it forms a line-type distribution or a point-type distribution. Therefore, the density of feature points should be calculated based on the distance between certain feature points. The pseudo primary vein and pseudo normal line are used for the calculation.

As shown in FIG. 7, the pseudo primary vein is defined as a straight line between the top end and the bottom end of the venation. Then, the line perpendicular to the pseudo primary vein is defined as the pseudo normal line. A distribution along the pseudo primary vein line can be detected by calculating the probability density function (PDF) of the distance between the BP and the primary vein line, and the distance where the density reaches its maximum value.

Similarly, a normal distribution can be verified by calculating the PDF of the distance from the pseudo normal line to the BP or to each feature point (BP and EP).

Therefore, the algorithm for calculating the PDF of the distance between the pseudo normal line and the feature points is presented in Table 2.

TABLE 2

```
function Density (distances, w_size)
{// distances is an array of distances of corners from a line
  minDist ← min(distances)
  maxDist ← max(distances)
  foreach r such that minDist <= r <= maxDist
    sum ← 0
    foreach d in distances
      if | r −d | / w_size < 0.5
        sum++
      endif
    endforeach
    kde[r] ← sum
  endforeach
return kde
}
```

On the other hand, the data processing computer (100) determines whether the feature points (BP and EP) are clustered around a point at the top end and bottom end, or if the feature points (BP and EP) are distributed along a line (S410) based on the previous step (S409) of the detected feature points. In the former case, the leaf is considered a parallel venation, and in the latter case the leaf is considered a non-parallel venation.

If the parallel venation is determined based on the previous decision step (S410), the data processing computer (100) analyzes whether the BP are distributed along a longitudinal line (or perpendicular line), which runs from top to bottom of the leaf, or lateral line, which runs side to side (S420). It will further verify whether the BP is densely clustered at the top end while the BP forms a line at the bottom of the leaf (S425).

At this point, if the BP are clustered densely at the top end and form a line at the bottom end along the pseudo primary vein, it is classified as a second parallel venation as presented in FIG. 2(c) (S427).

If the BP are densely clustered at the top end, while the BP at the bottom end are also densely clustered around a point, it is classified as a first parallel venation as presented in FIG. 2(b) (S428).

As shown in FIG. 8, an example calculation of the PDF for the feature points of the first parallel venation is presented, and a graph is plotted underneath thereof.

On the other hand, if the leaf has not been classified as the parallel venation according to the previous step (S410), the BP distribution is analyzed again to determine whether it is oriented along a longitudinal line or a lateral line (S430). The distribution of the BP is investigated as to whether it forms a line along the longitudinal line from the top end to the bottom end of the leaf (S435).

At this point, a Pinnate Venation can be classified if the BPs are densely distributed along a line from the top end to the bottom end as shown in FIG. 2(a) (S436).

Further, a Palmate Venation can be classified if the BP are densely clustered around a point at the lower bottom as shown in FIG. 2(d) (S439).

Accordingly, the storing unit (160) in the data processing computer (100) stores the leaf venations categorized into (a) pinnate venation, (b) first parallel venation, (c) second parallel venation and (d) palmate venation. Whenever the user needs a specific leaf venation, it will provide the information of the corresponding leaf venation to the users' computer (300).

As stated so far, the method for classifying leaves by using venation features of this invention is able to categorize and store the leaf venation of various plant leaves. Thus, the user can accurately retrieve information about the feature points extracted from the exclusive leaf venation patterns of the pinnate venation, first and second parallel venations and palmate venation.

So far, the present invention has been described in an illustrative manner and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for classifying a plant leaf by utilizing a feature point of venation, the method comprising the steps of:
extracting a sample image of venation from a leaf for inputting to an input unit (120), then searching for a similar sample image of a specimen venation to retrieve among the stored sample images of the various plant leaves through a retrieval unit (130) in a Data Supplying Computer (100) (S401),
detecting a series of Branching Points (BP) and Ending Points (EP) from the extracted sample image of venation by applying a Curvature Scale Space (CSS) Corner Detection Algorithm (S405),
classifying the extracted venation based on the detected BP and EP through an analysis unit (140) (S407),
verifying whether the detected feature points, BP and EP are distributed along a line or around a point by calculating the probability density function (PDF) of the feature points, BP and EP of the extracted venation using a Parzen Window non-parametric estimation technique (S409),
according to the PDFs calculated in the previous step, analyzing the distribution of feature points, BP and EP along a longitudinal line to detect a parallel venation if they are clustered around a point at the top and/or bottom, or a non-parallel venation, if the feature points, BP and EP are distributed along the longitudinal line (S410),
based on the previous decision step, if it is a case of the parallel venation, analyzing the distribution of the BP along the longitudinal and lateral lines (S420), further verifying whether the BP are densely clustered at the top while the BP form a line at the bottom (S425), and
classifying a second parallel venation if the BP are distributed along a line at the bottom end(S427), and further classifying a first parallel venation if the BP at the upper are densely clustered around a point, while the BP at the bottom end are densely clustered around a point (S428).

2. A method for classifying a plant leaf according to claim 1, wherein said analysis of the distribution of feature points further comprises the step of:
if a parallel venation has not been detected according to the previous decision step, analyzing the distribution of the BP along the longitudinal and lateral lines (S430), and investigating whether the BP are distributed along a longitudinal line running from the top to bottom of the leaf (S435), and
classifying a pinnate venation if the BP are distributed along a line from the top to the bottom (S436), and classifying a palmate venation if the BP are densely clustered around a point at the lower bottom (S439).

3. A method for classifying a plant leaf according to claim 1, wherein said method for extracting the sample image of venation applies a Canny Edge Detection technology to detect the shape of the feature points of the extracted venation.

4. A method for classifying a plant leaf according to claim 1, wherein said sample image of the extracted venation is treated to thicken the venation and increase the contrast through the retrieval unit (130) prior to applying the Canny Edge Detection technology.

5. A method for classifying a plant leaf according to claim 3, wherein said sample image of the extracted venation is treated to thicken the venation and increase the contrast through the retrieval unit (130) prior to applying the Canny Edge Detection technology.

6. A method for classifying a plant leaf according to claim 1, wherein said BP of the sample image calculates a curvature angle at the maximum points of the extracted venation and selects the points less than 90 degrees.
